(19) United States
(12) Patent Application Publication
(10) Pub. No.: US 2006/0123076 A1
(43) Pub. Date: Jun. 8, 2006

(54) Internet and tv data service browsing apparatus

(75) Inventor: Farzad Raiyat, Southampton (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/538,213

(22) PCT Filed: Nov. 27, 2003
(86) PCT No.: PCT/IB03/05547

§ 371 Date: Jun. 9, 2005

(30) Foreign Application Priority Data
Dec. 13, 2002 (GB) 0229251.4

(51) Int. Cl. G06F 15/16; H04N 5/445

(52) U.S. Cl. 709/203; 725/38

(57) ABSTRACT

Internet and TV data service browsing apparatus are disclose which are configured to display Internet pages retrieved from the Internet in response to a Internet address being inputted by a user and display TV data service data retrieved from a TV channel broadcast in response to a TV data service address being inputted by a user. In particular, such apparatus is disclosed with a common input mechanism with which a user may input both a Internet address and a TV data service address; and/or saving means for saving a TV data service data file in a file format which is viewable by the browser, which is composed of, contains or refers to the TV data service data, and which is saved either having a file name or having a directory structure indicating either the channel name or channel number of the TV channel.

This invention relates to Internet and TV data service browsing apparatus configured to display Internet pages retrieved from the Internet in response to a Internet address being inputted by a user and to display TV data service data retrieved from a TV channel broadcast in response to a TV data service address being inputted by a user.

At present It is known to provide TVs and TV set-top boxes which enable a user in one mode to browse the Internet and in another mode to browse TV data services includes World Standard Teletext (WST), digital equivalents to WST and digital interactive TV data services. Such TV data services may be provided by analogue and digital TV broadcasts, via terrestrial RF transmitter, cable (including telephone) and satellite mediums and in dedicated channels or multiplexed with video and audio signals.

Japanese patent application, publication number JP11-018060 discloses a TV set with which an incoming teletext stream can be viewed using a conventional Internet browser either by converting a teletext page in to an image file, such as JPEG, and referring to the image file in the header of a html file or by writing the teletext character data to a html file, and in either case, saving the html file to RAM.

It is an object of the invention to provide improved, integrated Internet and TV data service browsing apparatus.

In accordance with a first aspect of the present invention, Internet and TV data service browsing apparatus of the aforementioned type is provide with a common input mechanism, such as text entry in a text entry box displayed on the screen or selection of a particular type of hyperlink displayed on the display, with which a user may input both a Internet address and a TV data service address to display Internet pages and TV data service data respectively.

Such apparatus enables to seamlessly switch between Internet and TV data service browsing using a simplified, input mechanism common to both the Internet and TV browser.

Ideally, the TV data service address contains either the channel name or channel number of the TV channel so as to enable a user to distinguish between and select between TV data services of different TV channels.

Upon a user selecting a TV data service of a particular channel, the apparatus may attempt to retrieve corresponding TV data service data after such selection or, alternatively, the apparatus may retrieve such data from an appropriate cache. Hence, in accordance with a second aspect of the present invention, Internet and TV data service browsing apparatus of the aforementioned type is provided with saving means for saving a TV data service data file in a file format which is viewable by the browser, which is composed of, contains or refers to the TV data service data, and which is saved either having a file name or having a directory structure indicating either the channel name or channel number of the TV channel.

In particular, the saving means may do one or more of the following:
upon retrieving TV data service data in a file format which is viewable by the browser, save that file as the TV data service data file
upon retrieving TV data service data in a file format which is not viewable by the browser, first convert that file to a format which is viewable by the browser and then saves that converted file as the TV data service data file
upon retrieving TV data service data either in a file format which is not viewable by the browser or not in a file format, create or amend a file to containing either TV data service data retrieved from the TV channel or a reference to an associated file containing TV data service data retrieved from the TV channel, and then save that created or amended file as the TV data service data file.

Also provided in accordance with the second aspect of the present invention is a corresponding method as claimed in claims 9 to 12.

The present invention with now be described, by way of example, with reference to the following figures in which:

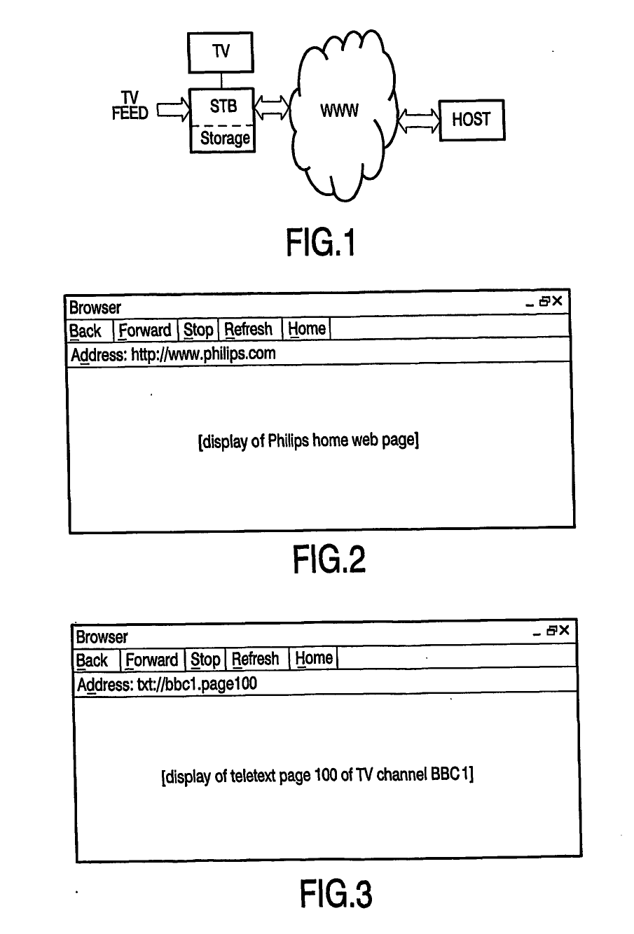

FIG. 1 show a TV set-top box operating in accordance with both aspects of the present invention; and

FIGS. 2 and 3 show screen displays generated by the set-top box of FIG. 1.

FIG. 1 shows an Internet enabled, TV set-top box in to which is fed both an analogue, terrestrially broadcasted TV feed with teletext data located in the vertical blanking internet and an Internet (www) feed from a telephone line.

The TV set-top box, which is connected to a corresponding TV, is able to operate, in accordance with the present invention, in a browser mode in which a user may enter in to the “Address” text entry box either a web url or a “teletext” url. That is, upon entering “http://www.philips.com”, the Philips home web page is displayed on the browser as shown in FIG. 2 (although the actual web page is not reproduced) and upon entering “txt://bbc1.page100”, page 100 of the BBC1 teletext service is displayed in the browser as shown in FIG. 3 (although the actual teletext data is not reproduced).

Retrieval of teletext data may be done in real time whereby the TV set-top box waits for that page to be transmitted and then converts the data on the fly to a format suitable for browsing. Alternatively, the teletext data may be retrieved beforehand, converted to a format suitable for browsing and then cached with a file name and/or directory structure indicating either the channel name or channel number of the TV channel.

Address data entry may be by done by using a conventional keyboard, keypad or remote control (none shown) used to control the set-top box.

Although an analogue TV feed is provided above, the TV feed could be either analogue or digital and from any suitable broadcasting source including terrestrial RF, satellite or cable. Similarly, the Internet feed in to the set-top box may be from any suitable Internet source including via cable, telephone or wireless LAN.

The integral storage may be writable optical or magnetic disc or solid state memory or any other suitable medium.

Implementation of the present invention in such a set-top box may be readily accomplished in hardware and/or software by appropriate programming and configuration. Of course, such programming and configuration is well known and would be accomplished by one of ordinary skill in the art without undue burden. It would be further understood by one of ordinary skill in the art that the teaching of the present invention applies equally to such apparatus integral with a TV or PC based such apparatus.

1. Internet and TV data service browsing apparatus configured to display Internet pages retrieved from the Internet in response to a Internet address being inputted by a user and to display TV data service data retrieved from a TV channel broadcast in response to a TV data service address being inputted by a user, characterised by a common input mechanism with which a user may input both a Internet address and a TV data service address to display Internet pages and TV data service data respectively.

2. Apparatus according to claim 1 wherein the input mechanism is text entry in a text entry box displayed on the screen.

3. Apparatus according to claim 1 wherein the input mechanism is the selection of a particular type of hyperlink displayed on the display.

4. Apparatus according to claim 1 wherein the TV data service address contains either the channel name or channel number of the TV channel.

5. Internet and TV data service browsing apparatus configured to display Internet pages retrieved from the Internet in response to a Internet address being inputted by a user and to display TV data service data retrieved from a TV channel broadcast in response to a TV data service address being inputted by a user, characterised by saving means for saving a TV data service data file in a file format which is viewable by the browser, which is composed of, contains or refers to the TV data service data, and which is saved either having a file name or having a directory structure indicating either the channel name or channel number of the TV channel.

6. Apparatus according to claim 5 wherein, upon retrieving TV data service data in a file format which is viewable by the browser, the saving means saves this file as the TV data service data file.

7. Apparatus according to claims 5 or 6 wherein, upon retrieving TV data service data in a file format which is not viewable by the browser, the saving means first converts that file to a format which is viewable by the browser and then saves that converted file as the TV data service data file.

8. Apparatus according to claims 5 wherein, upon retrieving TV data service data either in a file format which is not viewable by the browser or not in a file format, the saving means first creates or amends a file to containing either TV data service data retrieved from the TV channel or a reference to an associated file containing TV data service data retrieved from the TV channel, and then saves that created or amended file as the TV data service data file.

9. A method of providing browsing of Internet and TV data services comprising the steps of:
supporting a browser;
retrieving TV data service data from a TV channel; and
saving a TV data service data file which is composed of, contains or refers to the TV data service data in a file format which is viewable by the browser and with either a file name or directory structure indicating either the channel name or channel number of the TV channel.

10. A method according to claim 9 wherein upon retrieving TV data service data in a file format which is viewable by the browser, that file is saved as the TV data service data file.

11. A method according to claims 9 or 10 wherein, upon retrieving TV data service data in a file format which is not viewable by the browser, that file is first converted to a format which is viewable by the browser and then that converted file is saved as the TV data service data file.

12. A method according to claims 9 or 10 wherein, upon retrieving TV data service data either in a file format which is not viewable by the browser or not in a file format, a file is first created or amended to contain either TV data service data retrieved from the TV channel or a reference to an associated file containing TV data service data retrieved from the TV channel, and that created or amended file saved as the TV data service data file.
